(19) United States
(12) Patent Application Publication
(10) Pub. No.: US 2024/0143380 A1
(43) Pub. Date: May 2, 2024

(54) VIRTUAL MACHINE STATUS DETERMINATION METHOD AND SYSTEM, AND ELECTRONIC DEVICE

(71) Applicant: Lenovo (Beijing) Limited, Beijing (CN)

(72) Inventors: Shuaiyi ZHANG, Beijing (CN); Yang CHU, Beijing (CN); Haiqun YU, Beijing (CN)

(21) Appl. No.: 18/492,001

(22) Filed: Oct. 23, 2023

(30) Foreign Application Priority Data
Oct. 31, 2022 (CN) 202211343821.6

(51) Int. Cl. G06F 9/455

(52) U.S. Cl. CPC G06F 9/45558; G06F 2009/45591; G06F 2009/45595

(57) ABSTRACT

A virtual machine status determination method includes obtaining a message queue of a virtual network card or a virtual disk of a virtual machine, determining a message queue update status of the virtual network card or the virtual disk, and determining whether the virtual machine is currently in an internal abnormal state or a normal operating state based on the message queue update status.

### CROSS-REFERENCE TO RELATED APPLICATION

This application claims priority to Chinese Patent Application No. 202211343821.6, filed on Oct. 31, 2022, the entire content of which is incorporated herein by reference.

### TECHNICAL FIELD

The present disclosure generally relates to the field of virtual machine technologies and, more particularly, to a virtual machine status determination method, a virtual machine status determination system, and an electronic device.

### BACKGROUND

Two methods are usually used for detecting the running status of a virtual machine. In the first method, detecting is performed from outside the virtual machine through a network, such as through pinging the IP address of the virtual machine. When the virtual machine network is unavailable, it is determined that the inside of the virtual machine is in an inactive state. However, when this method is used, if the virtual machine prohibits network access such as ping, the virtual machine activity detection will fail, and the virtual machine will be marked as inactive.

In the second method, an agent software is installed in the virtual machine, and a detection program external to the virtual machine implements detection through interaction with the agent software. When the interaction fails, the virtual machine will be considered inactive. However, when this method is used, if the user deactivates the agent software in the virtual machine, the virtual machine activity detection will fail and the virtual machine will be marked as inactive.

### SUMMARY

In accordance with the present disclosure, there is provided a virtual machine status determination method including obtaining a message queue of a virtual network card or a virtual disk of a virtual machine, determining a message queue update status of the virtual network card or the virtual disk, and determining whether the virtual machine is currently in an internal abnormal state or a normal operating state based on the message queue update status.

In accordance with the present disclosure, there is also provided an electronic device including a memory and a processor. The memory stores a program. The processor is configured to execute the program to obtain a message queue of a virtual network card or a virtual disk of a virtual machine, determine a message queue update status of the virtual network card or the virtual disk, and determine whether the virtual machine is currently in an internal abnormal state or a normal operating state based on the message queue update status.

### BRIEF DESCRIPTION OF THE DRAWINGS

FIG. 1 is a flow chart of an example method for detecting the status of a virtual machine consistent with the present disclosure.

FIG. 2 is a flow chart of another example method for detecting the status of a virtual machine consistent with the present disclosure.

FIG. 3 is a flow chart of another example method for detecting a status of a virtual machine consistent with the present disclosure.

FIG. 4 is a flow chart of another example method for detecting the status of a virtual machine consistent with the present disclosure.

FIG. 5 is a schematic diagram of an architecture of a virtual machine activity detection consistent with the present disclosure.

FIG. 6 is a schematic diagram of a relationship between a virtual machine activity detection program and a host consistent with the present disclosure.

FIG. 7 is a structural diagram of a virtual machine status detection method consistent with the present disclosure.

FIG. 8 is a structural diagram of an electronic device consistent with the present disclosure.

### DETAILED DESCRIPTION OF THE EMBODIMENTS

Hereinafter, embodiments and features consistent with the present disclosure will be described with reference to drawings.

Various modifications may be made to the embodiments of the present disclosure. Thus, the described embodiments should not be regarded as limiting, but are merely examples. Those skilled in the art will envision other modifications within the scope and spirit of the present disclosure.

The accompanying drawings, which are incorporated in and constitute a part of this specification, illustrate embodiments of the present disclosure and, together with the general description of the present disclosure above and the detailed description of the embodiments below, serve to explain the principle of the present disclosure.

These and other features of the present disclosure will become apparent from the following description of non-limiting embodiments with reference to the accompanying drawings.

Although the present disclosure is described with reference to some specific examples, those skilled in the art will be able to realize many other equivalents of the present disclosure.

The above and other aspects, features, and advantages of the present disclosure will become more apparent in view of the following detailed description when taken in conjunction with the accompanying drawings.

Specific embodiments of the present disclosure are hereinafter described with reference to the accompanying drawings. The described embodiments are merely examples of the present disclosure, which may be implemented in various ways. Specific structural and functional details described herein are not intended to limit, but merely serve as a basis for the claims and a representative basis for teaching one skilled in the art to variously employ the present disclosure in substantially any suitable detailed structure.

In the present disclosure, the phrases such as “in one embodiment,” “in another embodiment,” “in yet another embodiment,” or “in other embodiments,” may all refer to one or more of different embodiments in accordance with the present disclosure.

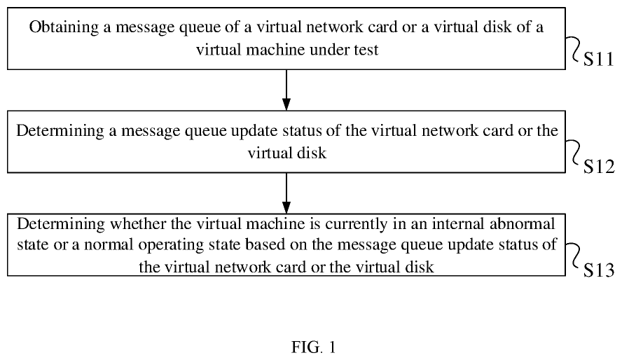

The present disclosure provides a virtual machine status determination method. As shown in FIG. 1 which is a flow chart of a virtual machine status determination method provided by one embodiment of the present disclosure, the method includes:
S11: obtaining a message queue of a virtual network card or a virtual disk of a virtual machine under test (also referred to as a “target virtual machine”);
S12: determining a message queue update status of the virtual network card or virtual disk; and
S13: determining whether the virtual machine is currently in an internal abnormal state or a normal operating state based on the message queue update status of the virtual network card or the virtual disk.

A virtual machine may be emulated through a virtual machine emulator. The virtual machine may include corresponding virtual devices such as the virtual disk or the virtual network card. Since the virtual disk, the virtual network card, or another virtual device of the virtual machine is emulated by the virtual machine emulator on a host, the information of these virtual devices may be detected on the host. Therefore, by judging the changes of the information of these virtual devices, it may be determined whether the virtual machine is active.

When it is needed to detect the status of the virtual machine, the message queue of the virtual network card or the virtual disk of the virtual machine under test may be directly obtained, and the update status of the message queue may be determined, to determine whether the virtual machine is currently in the internal abnormal state or in the normal operating state based on the message queue update status.

The message queue of the virtual network card may include a message sending queue or a message receiving queue. The message queue of the virtual disk may include a message request queue.

When the message sending queue of the virtual network card is being updated, it may indicate that the virtual disk is actively sending data out, indicating that the virtual machine is currently active, that is, in the normal operating state. When the message receiving queue in the virtual disk is being updated, it may indicate that the virtual disk is able to obtain and process messages sent by the outside world, indicating that the virtual machine is currently active, that is, in the normal operating state. When the message request queue in the virtual network card is being updated, regardless of whether the update of the message request queue corresponds to a read request or a write request or other requests, it may indicate that the virtual machine is currently active, that is, in the normal operating state.

When the message sending queue of the virtual network card is not updated for a long time, the message receiving queue in the virtual network card is not continuously updated, and the message request queue of the virtual disk is not updated for a long time, it may be determined that the virtual machine is currently in the internal abnormal state. Only when the message sending queue and the message receiving queue of the virtual network card, and the message request queue of the virtual slave disk are not updated for a long time, it may be determined that the virtual machine is currently in the internal abnormal state.

Also, when the message receiving queue of the virtual network card is in a continuous overflow state, it may be determined that the virtual machine is currently in the internal abnormal state. At this time, there may be no need to determine whether the message sending queue of the virtual network card is updated, and there may be also no need to determine whether the message request queue of the virtual disk is updated.

The continuous overflow state of the message receiving queue may include that the message receiving queue is able to receive messages sent from the outside world but cannot process the received messages, causing the message receiving queue to overflow. When the message receiving queue of the virtual network card of the virtual machine is in the continuous overflow state, it may be determined that the virtual machine is in the internal abnormal state.

Determination of the operating status of the virtual machine through the updating status of the message sending queue or message receiving queue of the virtual network card or the message request queue of the virtual disk, the operating status of the virtual machine may be determined directly based on the information sending and receiving within the virtual machine, without the help of other software or other networks. Therefore, the error in virtual machine status determination caused by internal restrictions on other software or other networks in the virtual machine may be avoided, improving the accuracy of virtual machine status determination.

In the virtual machine status determination method provided by the embodiments of the present disclosure, the message queue of the virtual network card or virtual disk of the virtual machine under test may be obtained, and the message queue update status of the virtual network card or virtual disk may be determined. Correspondingly, whether the virtual machine is currently in an internal abnormal state or a normal operating state may be determined based on the message queue update status of the virtual network card or virtual disk. Therefore, whether the virtual machine is in the normal operating state may be determined through the message queue update status of the virtual network card or virtual disk of the virtual machine under test, and this process may not require the use of other software or networks and may not be affected by other software or network settings. The accuracy of virtual machine status determination may be improved.

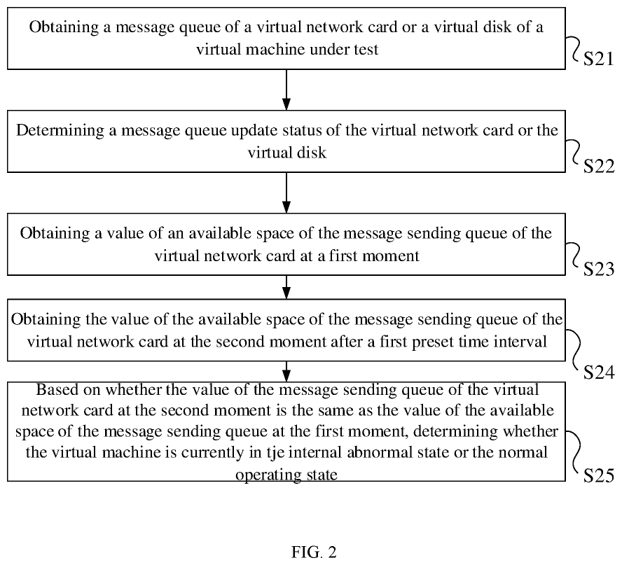

The present disclosure also provides another virtual machine status determination method. As shown in FIG. 2, the method includes:
S21: obtaining a message queue of a virtual network card or a virtual disk of a virtual machine under test;
S22: determining a message queue update status of the virtual network card or virtual disk;
S23: obtaining a value of an available space of the message sending queue of the virtual network card at a first moment;
S24. after a first preset time interval, obtaining the value of the available space of the message sending queue of the virtual network card at the second moment; and
S25. based on whether the value of the available space of the message sending queue at the second moment is same as the value of the available space of the message sending queue at the first moment, determining whether the virtual machine is currently in the internal abnormal state or the normal operating state.

The message queue usually consists of three parts including the available space avail, the used space used and the address space array desc. The available space avail and the used space used may represent the position in the address space array desc. That is, the location of a data in the address space array desc may be determined through the subscript. For example, when data “abc” is sent out from the virtual machine, a subscript may be obtained from avail.idx in the available space avail, and the subscript may be idx. When the obtained subscript is 10, “abc” may be placed at the 10th position of the address space array desc.

When determining the update status of the message sending queue of the virtual network card, it may be needed to determine whether the value of the available space of the message sending queue of the virtual network card changes at different times.

The value of the available space of the message sending queue of the virtual network card at the first moment may be obtained first. Then, after the first preset time interval, the value of the available space of the message sending queue of the virtual network card at the second moment may be obtained. Whether the value of the available space of the message sending queue at the second moment is same as the value of the available space of the message sending queue at the first moment may be determined.

The value of available space avail.idx of the message sending queue of the virtual network card at the first moment may be obtained and saved, for example, to last_tx_avail_idx. After the first preset time interval, the value of the available space avail.idx of the message sending queue of the virtual network card at the second moment may be obtained. The currently obtained value may be compared with the value read and saved to last_tx_avail_idx at the first moment.

When the two values are different, it may be determined that the numbers of messages sent by the virtual network card of the virtual machine within the first preset time interval from the first moment to the second moment are different, which means that the virtual machine send out network data within the first preset time interval from the first moment to the second moment. Therefore, it may be determined that the virtual machine is currently in the normal operation status. Further, the value of avail.idx read at the second moment may be saved to last_tx_avail_idx to replace the value stored at the first moment.

When the virtual machine sends data, the value of avail.idx of the available space in the virtual machine may be first updated. At this time, the virtual machine emulator of the host computer may read the change of the value of avail.idx in the virtual machine, and process the corresponding data in the address space array desc. When the processing is completed, used.idx on the virtual machine emulator of the host computer may change. Based on the changes of used.idx, the virtual machine may be able to determine that the data it sent has been processed, that is, the complete process of sending packet is realized.

Further, when the value of the available space of the message sending queue of the virtual network card of the virtual machine does not change within the first preset time interval from the first moment to the second moment, it may be determined that the virtual machine does not send messages to the outside within this period. When it needs to further determine whether the virtual machine is currently in the internal abnormal state, the message receiving queue of the virtual network card and/or the message request queue of the virtual disk may be needed to jointly determine, rather than determining that the virtual machine is currently in the internal abnormal state just based on that the available space of the message sending queue of the virtual network card does not change within the first preset time interval. The accuracy of determining the current running status of the virtual machine may be ensured.

The message queues on the virtual machine and on the virtual machine emulator of the host may be shared. When the message queue on the virtual machine emulator of the host changes, the message queue on the virtual machine may also change accordingly. For example, when used.idx in the message sending queue on the virtual machine emulator of the host changes, the virtual machine may directly determine that its used.idx has changed.

In the virtual machine status determination method provided by embodiments of the disclosure, the message queue of the virtual network card or the virtual disk of the virtual machine under test may be obtained. The message queue update status of the virtual network card or virtual disk may be determined. The value of the available space of the message sending queue of the virtual network card at the first moment may be obtained. After the first preset time interval, the value of the available space of the message sending queue of the virtual network card at the second moment may be obtained. Based on whether the value of the available space of the message sending queue at the second moment is same as the value of the available space of the message sending queue at the first moment, whether the virtual machine is currently in the internal abnormal state or the normal operating state may be determined. Therefore, whether the virtual machine is in the normal operation may be determined through the message queue update status of the virtual network card or virtual disk of the virtual machine under test, and this process may not require the use of other software or networks and may not be affected by other software or network settings. The accuracy of virtual machine status determination may be improved.

In another embodiment, whether the virtual machine is currently in the internal abnormal state or the normal operating state may be determined by:
obtaining the value of the available space of the message request queue of the virtual disk at a fifth moment; after a third preset time interval, obtaining the value of the available space of the message request queue of the virtual disk at a sixth moment; and determining whether the virtual machine is currently in the internal abnormal state or the normal operating state based on whether the value of the available space of the message request queue at the fifth moment is same as the value of the available space of the message request queue at the sixth moment.

Messages in the message request queue of the virtual disk may at least include information such as reading the disk, writing the disk, or modifying the disk attributes. No matter what kind of information is requested, it may be only implemented through one message request queue. As long as there is information interaction or modification in the disk, the message request queue will change. Therefore, the value of the available space of the message request queue may be monitored directly. When the values monitored at two moments are different, it may be determined that there are request messages in the virtual disk during the two monitoring moments, indicating that the virtual machine is currently active, that is, in the normal operating state.

When the values monitored at two moments are the same, it may be indicated that the virtual disk does not request messages during the two monitoring moments. At this time, it may be needed to further use the message queue of the virtual network card to determine whether the virtual machine is currently active, and it may be not good to determine that the virtual machine was in the internal abnormal state only based on that the disk does not request messages during the two monitoring moments.

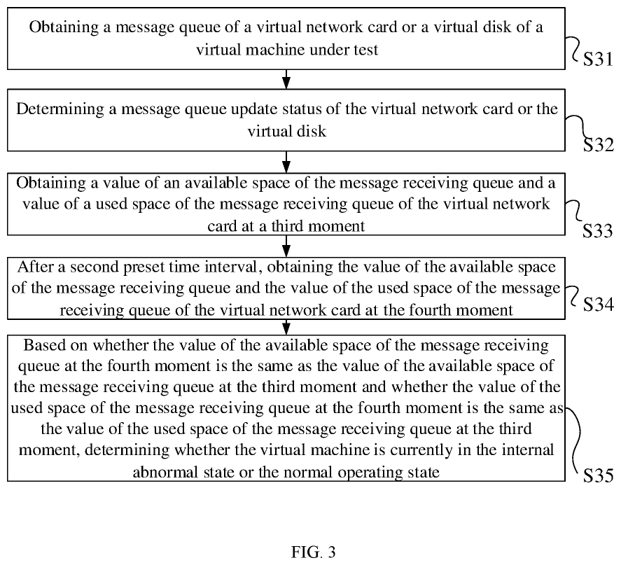

The present disclosure also provides another virtual machine status determination method. As shown in FIG. 3, the method includes:
S31: obtaining a message queue of a virtual network card or a virtual disk of a virtual machine under test;
S32: determining a message queue update status of the virtual network card or virtual disk;
S33: obtaining a value of an available space of the message receiving queue and a value of a used space of the message receiving queue of the virtual network card at a third moment;
S34. after a third preset time interval, obtaining the value of the available space of the message receiving queue and the value of the used space of the message receiving queue of the virtual network card at a fourth moment; and
S35. based on whether the value of the available space of the message receiving queue at the fourth moment is same as the value of the available space of the message receiving queue at the third moment and whether the value of the used space of the message receiving queue at the fourth moment is same as the value of the used space of the message receiving queue at the third moment, determining whether the virtual machine is currently in the internal abnormal state or the normal operating state.

When determining whether the virtual machine is currently in the internal abnormal state through the message receiving queue of the virtual network card, the value of the available space and the value of the used space of the message receiving queue at different times may be used to comprehensively determine whether the data transferred to the virtual network card from the outside can be successfully received.

Determining whether data incoming from the outside to the virtual network card can be successfully received may actually be determining whether the message receiving queue of the virtual network card is in a continuous overflow state. When the message receiving queue of the virtual network card is in the continuous overflow state, it may be determined that the update status of the message receiving queue of the virtual network card is a non-continuous update state, and thus it may be determined that the virtual machine is currently in the internal abnormal state. When it is determined that the message receiving queue of the virtual network card is not in the continuous overflow state, it may be determined that the update status of the message receiving queue of the virtual network card is a continuous updating state and it may be determined that the message receiving status of the virtual network card is currently in normal operation. To further determine whether the virtual machine is currently in the normal operating state, it may be needed to make a comprehensive determination based on the message sending queue of the virtual network card and the message request queue of the virtual disk.

Whether the message receiving queue of the virtual network card is in the continuous overflow state may be determined based on whether the value of the available space of the message receiving queue at the fourth moment is same as the value of the available space of the message receiving queue at the third moment and whether the value of the used space of the message receiving queue at the fourth moment is same as the value of the used space of the message receiving queue at the third moment.

When it is determined that the value of the available space of the message receiving queue at the fourth moment is different from the value of the available space of the message receiving queue at the third moment, it may be determined that the virtual machine is in the normal operating state. When the value of the available space of the message receiving queue at the fourth moment is same as the value of the available space of the message receiving queue at the third moment and the value of the used space of the message receiving queue at the fourth moment is same as the value of the used space of the message receiving queue at the third moment, it may be determined that the message receiving queue of the virtual network card is in the continuous overflow state and the virtual machine is in the internal abnormal state.

When the virtual network card receives a message, the virtual network card may first update used.idx in the message receiving queue of the host, and then the virtual machine may updates available.idx. Since the virtual network card is able to receive multiple messages continuously when receiving messages, used.idx in the message receiving queue may usually grow faster than avail.idx when the virtual network card receives messages normally, and used.idx in the message receiving queue may be larger than avail.idx in the message receiving queue.

When avail.idx and used.idx in the message receiving queue are equal to each other at a certain moment, it may be indicated that there is no space in the virtual network card to continue receiving data. At this time, when the virtual machine is in the normal operating state, avail.idx in the message receiving queue may be updated to ensure that the virtual machine is able to receive data normally. When avail.idx in the message receiving queue is not updated, the message receiving queue may be in the continuous overflow state.

Therefore, when the value of the available space avail.idx is the same as the value of the used space used.idx in the message receiving queue at the third moment, it may be needed to determine whether the value of the available space of the message receiving queue at the fourth moment is same as the value of the available space of the message receiving queue at the third moment. When the value of the available space of the message receiving queue at the fourth moment is same as the value of the available space of the message receiving queue at the third moment, it may be determined that available.idx in the message receiving queue has not been updated, which means that the message receiving queue is in the continuous overflow state. When the value of the available space of the message receiving queue at the fourth moment is different from the value of the available space of the message receiving queue at the third moment; it may be determined that avail.idx in the queue is updated and the message receiving queue is in a normal state without continuous overflow.

The fourth moment is a moment separated by the second preset time interval from the third moment. The second preset time interval, the first preset time interval and the third preset time interval may be the same or different, which is not limited in the present disclosure.

In the virtual machine status determination method provided by embodiments of the disclosure, the message queue of the virtual network card or the virtual disk of the virtual machine under test may be obtained. The message queue update status of the virtual network card or virtual disk may be determined. The value of the available space of the message receiving queue and the value of the used space of the message receiving queue of the virtual network card at a third moment may be obtained. After the third preset time interval, the value of the available space of the message receiving queue and the value of the used space of the message receiving queue of the virtual network card at a fourth moment may be obtained. Based on whether the value of the available space of the message receiving queue at the fourth moment is same as the value of the available space of the message receiving queue at the third moment and whether the value of the used space of the message receiving queue at the fourth moment is same as the value of the used space of the message receiving queue at the third moment, whether the virtual machine is currently in the internal abnormal state or the normal operating state may be determined. Therefore, whether the virtual machine is in the normal operation may be determined through the message queue update status of the virtual network card or virtual disk of the virtual machine under test, and this process may not require the use of other software or networks and may not be affected by other software or network settings. The accuracy of virtual machine status determination may be improved.

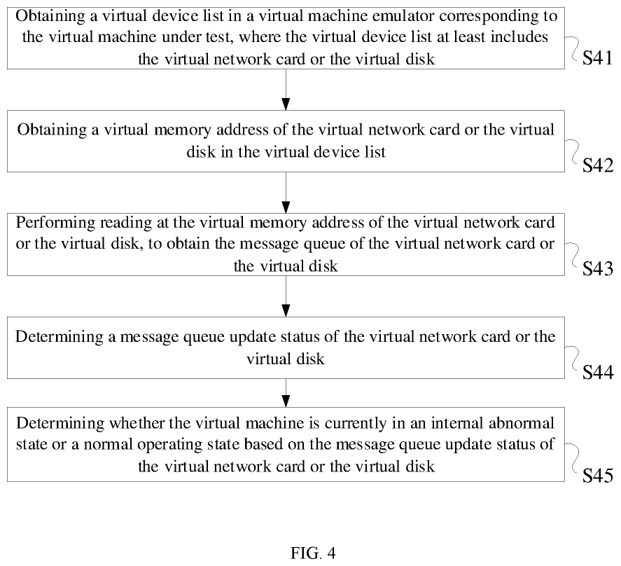

The present disclosure also provides another virtual machine status determination method. As shown in FIG. 4, the method includes:
S41: obtaining a virtual device list in the virtual machine emulator corresponding to the virtual machine under test, where the virtual device list at least includes a virtual network card or a virtual disk;
S42: obtaining a virtual memory address of the virtual network card or virtual disk in the virtual device list;
S43: performing reading at the virtual memory address of the virtual network card or virtual disk to obtain a message queue of the virtual network card or the virtual disk;
S44: determining a message queue update status of the virtual network card or virtual disk; and
S45. based on the message queue update status of the virtual network card or virtual disk, determining whether the virtual machine is currently in the internal abnormal state or the normal operating state.

The virtual machine emulator may be used to emulate and create the structure of the virtual machine on the host. When emulating the virtual machine, the virtual machine emulator may also emulate the virtual devices of the virtual machine. After emulating the virtual devices of the virtual machine, the virtual device list may be stored, which is used to record information such as names and addresses of the virtual devices of the virtual machine emulated by the virtual machine emulator.

The virtual devices may at least include the virtual network card and the virtual disk. After obtaining the virtual device list of the virtual machine, the virtual memory address of the virtual network card or the virtual memory address of the virtual disk may be obtained based on the virtual device list. Then the corresponding message queue may be obtained from the storage area at the virtual memory address. That is, the message sending queue and message receiving queue of the virtual network card may be obtained from the storage area at the virtual memory address of the virtual network card, or the message request queue of the virtual disk may be obtained from the storage area at the virtual memory address of the virtual disk. Therefore, after the message queue of the virtual network card or virtual disk is obtained, it may be determined whether the virtual machine is currently in the internal abnormal state or the normal operating state based on the updated status of the message queue.

The message queue of the virtual network card or virtual disk may be determined through the virtual device list and the virtual memory address of the virtual device, and further the operating status of the virtual machine may be determined. When the virtual machine emulator creates the virtual devices in the virtual machine, a virtual device list interface may be needed such that the virtual device list is able to be called through this interface. It may be also needed to add a virtual device information interface, such that the virtual device information

The message queue of the virtual network card or virtual disk may be obtained from the storage area at the virtual memory address, and the virtual memory address may be in the virtual machine emulator of the host. Therefore, the determination of the virtual machine operation status may be achieved directly based on the data in the virtual machine emulator without probing inside the virtual machine.

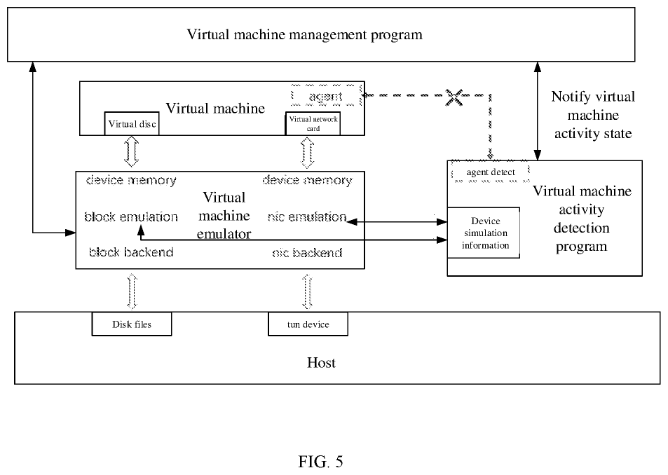

A virtual machine activity detection program may be used to detect the operating status of the virtual machine. FIG. 5 is a schematic diagram of the activity detection architecture provided by one embodiment of the present disclosure. As shown in FIG. 5, the activity detection architecture may include a host 51, a virtual machine 52, a virtual machine emulator 53, a virtual machine activity detection program 54, and a virtual machine management program 55. The host may realize the emulation of the virtual machine through the virtual machine emulator, and emulate the virtual devices in the virtual machine. Device information, that is, the information related to the virtual device emulated by the virtual machine emulator, may be stored in the virtual machine activity detection program. The virtual memory address of the virtual device may be stored in the virtual machine emulator. When the virtual machine activity detection program needs to detect the status of the virtual machine, the virtual machine activity detection program may directly obtain the device emulation information in the virtual machine emulator, and obtain the virtual memory addresses of the virtual devices from the virtual machine emulator based on the device emulation information. Then, the operation status of the virtual machine may be determined and may be fed back to the virtual machine management program, such that the virtual machine management is able to control and manage the virtual machine based on the operation status.

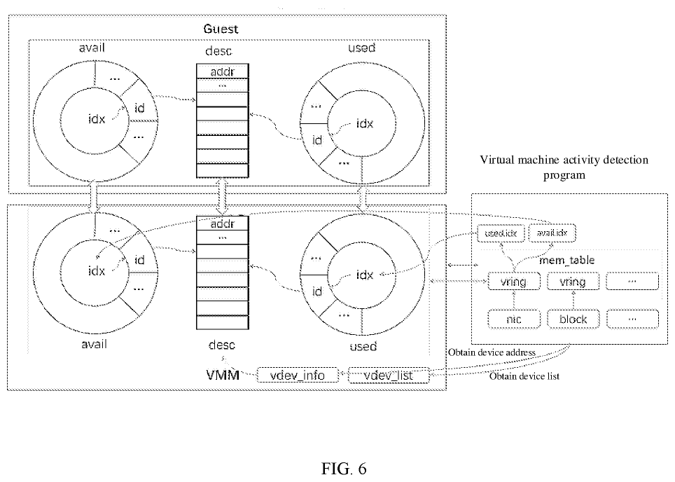

FIG. 6 is a schematic diagram showing the virtual machine activity detection program obtaining the information of the virtual machine from the host. In FIG. 6, Guest is the virtual machine and VMM is the host. The memory area occupied by the message queues in the virtual machine and in the host may correspond to each other. When the message queue in the virtual machine changes, the message queue in the host may change accordingly. The virtual device list vdev_list and virtual device information vdev_info may be stored in the host. The virtual machine activity detection program may obtain the virtual device list vdev_list and the virtual device information vdev_info from the host to determine the virtual memory addresses of the virtual devices and determine whether the virtual machine is currently in the internal abnormal state or the normal operating state. nic is the network card, nic emulation is the virtual network card, block is the disk, and block emulation is the virtual disk.

In the virtual machine status determination method provided by embodiments of the disclosure, the virtual device list in the virtual machine emulator corresponding to the virtual machine under test may be obtained, where the virtual device list at least includes a virtual network card or a virtual disk. The virtual memory address of the virtual network card or virtual disk in the virtual device list may be obtained subsequently. The message queue of the virtual network card or the virtual disk may be obtained through performing reading at the virtual memory address of the virtual network card or virtual disk. The message queue update status of the virtual network card or virtual disk may be obtained. Subsequently, based on the message queue update status of the virtual network card or virtual disk, whether the virtual machine is currently in the internal abnormal state or the normal operating state may be determined. Therefore, whether the virtual machine is in the normal operation may be determined through the message queue update status of the virtual network card or virtual disk of the virtual machine under test, and this process may not require the use of other software or networks and may not be affected by other software or network settings. The accuracy of virtual machine status determination may be improved.

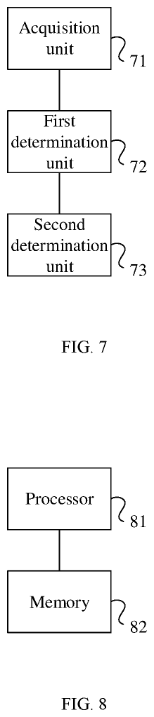

The present disclosure also provides a virtual machine status determination system. As shown in FIG. 7, the system includes an acquisition unit 71, a first determination unit 72, and a second determination unit 73.

The obtaining unit 71 may be configured to obtain the message queue of the virtual network card or the virtual disk of the virtual machine under test.

The first determining unit 72 may be configured to determine the message queue update status of the virtual network card or the virtual disk.

The second determining unit 73 may be configured to determine whether the virtual machine is in the normal operating state or in the internal abnormal state according to the message queue update status of the virtual network card or virtual disk of the virtual machine under test.

In one embodiment, the second determination unit may be also configured to: determine that the virtual machine is currently in the normal operating state when determining that the message queue update status of the virtual network card or the virtual disk is a continuous update state; and determine that the virtual machine is currently in the internal abnormal state when is determined that the message queue update status of the virtual network card or the virtual disk is not a continuous update state.

In one embodiment, the second determination unit may be further configured to: obtain the value of the available space of the message sending queue of the virtual network card at the first moment; obtain the value of the available space of the message sending queue of the virtual network card at the second moment after the first preset time interval; and, based on whether the value of the available space of the message sending queue at the second moment is the same as the value of the available space of the message sending queue at the first moment, determine whether the virtual machine is in the normal operating state or in the internal abnormal state.

In one embodiment, the second determination unit may be further configured to: when it is determined that the message receiving queue of the virtual network card is in a continuous overflow state, determine that the virtual machine is currently in the internal abnormal state.

In one embodiment, the second determination unit may be further configured to:
obtain a value of an available space of the message receiving queue and a value of a used space of the message receiving queue of the virtual network card at a third moment; after a third preset time interval, obtain the value of the available space of the message receiving queue and the value of the used space of the message receiving queue of the virtual network card at a fourth moment; and, based on whether the value of the available space of the message receiving queue at the fourth moment is same as the value of the available space of the message receiving queue at the third moment and whether the value of the used space of the message receiving queue at the fourth moment is same as the value of the used space of the message receiving queue at the third moment, determine whether the virtual machine is currently in the internal abnormal state or the normal operating state.

In one embodiment, the second determination unit may be further configured to:
when it is determined that the value of the available space of the message receiving queue at the fourth moment is different from the value of the available space of the message receiving queue at the third moment, determine that the virtual machine is currently in the normal operating state; and when it is determined that the value of the available space of the message receiving queue at the fourth moment is same as the value of the available space of the message receiving queue at the third moment and the value of the used space of the message receiving queue at the fourth moment is same as the value of the used space of the message receiving queue at the third moment, determine that the virtual machine is currently in the internal abnormal state.

In one embodiment, the second determination unit may be further configured to:
obtain the value of the available space of the message request queue of the virtual disk at a fifth moment; after a third preset time interval, obtain the value of the available space of the message request queue of the virtual disk at a sixth moment; and determine whether the virtual machine is currently in the internal abnormal state or the normal operating state based on whether the value of the available space of the message request queue at the fifth moment is same as the value of the available space of the message request queue at the sixth moment.

In one embodiment, the acquisition unit may be configured to:
obtain a virtual device list in the virtual machine emulator corresponding to the virtual machine under test, where the virtual device list at least includes a virtual network card or a virtual disk; obtain a virtual memory address of the virtual network card or virtual disk in the virtual device list; and obtain the message queue of the virtual network card or the virtual disk by performing reading at the virtual memory address of the virtual network card or virtual disk.

For the details of the virtual machine status determination system, reference may be made to the virtual machine status determination method in the previous embodiments.

In the virtual machine status determination system provided by the present disclosure, the message queue of the virtual network card or virtual disk of the virtual machine under test may be obtained, and the message queue update status of the virtual network card or virtual disk may be determined. Correspondingly, whether the virtual machine is currently in an internal abnormal state or a normal operating state may be determined based on the message queue update status of the virtual network card or virtual disk. Therefore, whether the virtual machine is in the normal operation may be determined through the message queue update status of the virtual network card or virtual disk of the virtual machine under test, and this process may not require the use of other software or networks and may not be affected by other software or network settings. The accuracy of virtual machine status determination may be improved.

The present disclosure also provides an electronic device. As shown in FIG. 8, the device includes a processor 81 and a memory 82.

The processor 81 may be configured to: obtain the message queue of the virtual network card or the virtual disk of the virtual machine under test; determine the message queue update status of the virtual network card or the virtual disk; and determine whether the virtual machine is in the normal operating state or in the internal abnormal state according to the message queue update status of the virtual network card or virtual disk of the virtual machine under test.

The memory 82 may be configured to store an application program for executing the above processes.

For the details of the electronic device, reference may be made to the virtual machine status determination method in the previous embodiments.

In the electronic device provided by the present disclosure, the message queue of the virtual network card or virtual disk of the virtual machine under test may be obtained, and the message queue update status of the virtual network card or virtual disk may be determined. Correspondingly, whether the virtual machine is currently in an internal abnormal state or a normal operating state may be determined based on the message queue update status of the virtual network card or virtual disk. Therefore, whether the virtual machine is in the normal operation may be determined through the message queue update status of the virtual network card or virtual disk of the virtual machine under test, and this process may not require the use of other software or networks and may not be affected by other software or network settings. The accuracy of virtual machine status determination may be improved.

Each embodiment in this specification is described in a progressive manner, and each embodiment focuses on the difference from other embodiments. Same and similar parts of each embodiment may be referred to each other. As for the device disclosed in the embodiments, since it corresponds to the method disclosed in the embodiments, the description is relatively simple, and for relevant details, the reference may be made to the description of the method embodiments.

Units and algorithm steps of the examples described in conjunction with the embodiments disclosed herein may be implemented by electronic hardware, computer software or a combination of the two. To clearly illustrate the possible interchangeability between the hardware and software, in the above description, the composition and steps of each example have been generally described according to their functions. Whether these functions are executed by hardware or software depends on the specific application and design constraints of the technical solution. Those skilled in the art may use different methods to implement the described functions for each specific application, but such implementation should not be regarded as exceeding the scope of the present disclosure.

The steps of the methods or algorithms described in connection with the embodiments disclosed herein may be directly implemented by hardware, software modules executed by a processor, or a combination of both. Software modules may be placed in a random access memory (RAM), an internal memory, a read-only memory (ROM), an electrically programmable ROM, an electrically erasable programmable ROM, a register, a hard disk, a removable disk, a CD-ROM, or any other storage medium.

Various embodiments have been described to illustrate the operation principles and exemplary implementations. It should be understood by those skilled in the art that the present disclosure is not limited to the specific embodiments described herein and that various other obvious changes, rearrangements, and substitutions will occur to those skilled in the art without departing from the scope of the present disclosure. Thus, while the present disclosure has been described in detail with reference to the above described embodiments, the present disclosure is not limited to the above described embodiments, but may be embodied in other equivalent forms without departing from the scope of the present disclosure.

What is claimed is:

1. A virtual machine status determination method comprising:
obtaining a message queue of a virtual network card or a virtual disk of a virtual machine;
determining a message queue update status of the virtual network card or the virtual disk; and
determining whether the virtual machine is currently in an internal abnormal state or a normal operating state based on the message queue update status.

2. The method according to claim 1, wherein determining whether the virtual machine is currently in the internal abnormal state or the normal operating state based on the message queue update status includes:
obtaining a first value of an available space of a message sending queue of the virtual network card at a first moment;
obtaining a second value of the available space at a second moment that is after the first moment; and
determining whether the virtual machine is currently in the internal abnormal state or the normal operating state based on whether the first value is same as the second value.

3. The method according to claim 1, wherein determining whether the virtual machine is currently in the internal abnormal state or the normal operating state based on the message queue update status includes:
in response to the message queue update status being a continuous update state, determining that the virtual machine is currently in the normal operating state; and
in response to the message queue update status being a non-continuous update state, determining that the virtual machine is currently in the internal abnormal state.

4. The method according to claim 3, wherein, in response to the message queue update status being the non-continuous update state, determining that the virtual machine is currently in the internal abnormal state, includes:
in response to a message receiving queue of the virtual network card being in a continuous overflow state, determining that the virtual machine is currently in the internal abnormal state.

5. The method according to claim 4, wherein determining whether the virtual machine is currently in the internal abnormal state or the normal operating state based on the message queue update status includes:
obtaining a first value of an available space of the message receiving queue and a first value of a used space of the message receiving queue at a first moment;
obtaining a second value of the available space and a second value of the used space at a second moment after the first moment; and
determining whether the virtual machine is currently in the internal abnormal state or the normal operating state based on whether the first value of the available space is same as the second value of the available space and whether the first value of the used space is same as the second value of the used space.

6. The method according to claim 5, wherein, determining whether the virtual machine is currently in the internal abnormal state or the normal operating state based on whether the first value of the available space is same as the second value of the available space and whether the first value of the used space is same as the second value of the used space includes:
in response to the first value of the available space being different from the second value of the available space, determining that the virtual machine is currently in the normal operating state; and
in response to the first value of the available space being same as the second value of the available space and the first value of the used space being same as the second value of the used space, determining the virtual machine is currently in the internal abnormal state.

7. The method according to claim 1, wherein determining whether the virtual machine is currently in the internal abnormal state or the normal operating state based on the message queue update status includes:
obtaining a first value of an available space of a message request queue of the virtual disk at a first moment;
obtaining a second value of the available space at a second moment after the first moment; and
determining whether the virtual machine is currently in the internal abnormal state or the normal operating state based on whether the first value is same as the second value.

8. The method according to claim 1, wherein obtaining the message queue of the virtual network card or the virtual disk of the virtual machine includes:
obtaining a virtual device list in a virtual machine emulator corresponding to the virtual machine, the virtual device list at least including the virtual network card or the virtual disk;
obtaining a virtual memory address of the virtual network card or the virtual disk in the virtual device list;
performing reading at the virtual memory address to obtain the message queue of the virtual network card or the virtual disk.

9. An electronic device comprising:
a memory storing a program; and
a processor configured to execute the program to:
obtain a message queue of a virtual network card or a virtual disk of a virtual machine;
determine a message queue update status of the virtual network card or the virtual disk; and
determine whether the virtual machine is currently in an internal abnormal state or a normal operating state based on the message queue update status.

10. The electronic device according to claim 9, wherein the processor is further configured to execute the program to:
obtain a first value of an available space of a message sending queue of the virtual network card at a first moment;
obtain a second value of the available space at a second moment that is after the first moment; and
determine whether the virtual machine is currently in the internal abnormal state or the normal operating state based on whether the first value is same as the second value.

11. The electronic device according to claim 9, wherein the processor is further configured to execute the program to:
in response to the message queue update status being a continuous update state, determine that the virtual machine is currently in the normal operating state; and
in response to the message queue update status being a non-continuous update state, determine that the virtual machine is currently in the internal abnormal state.

12. The electronic device according to claim 11, wherein the processor is further configured to execute the program to:
in response to a message receiving queue of the virtual network card being in a continuous overflow state, determine that the virtual machine is currently in the internal abnormal state.

13. The electronic device according to claim 12, wherein the processor is further configured to execute the program to:
obtain a first value of an available space of the message receiving queue and a first value of a used space of the message receiving queue at a first moment;
obtain a second value of the available space and a second value of the used space at a second moment after the first moment; and
determine whether the virtual machine is currently in the internal abnormal state or the normal operating state based on whether the first value of the available space is same as the second value of the available space and whether the first value of the used space is same as the second value of the used space.

14. The electronic device according to claim 13, wherein the processor is further configured to execute the program to:
in response to the first value of the available space being different from the second value of the available space, determine that the virtual machine is currently in the normal operating state; and
in response to the first value of the available space being same as the second value of the available space and the first value of the used space being same as the second value of the used space, determine the virtual machine is currently in the internal abnormal state.

15. The electronic device according to claim 9, wherein the processor is further configured to execute the program to:
obtain a first value of an available space of a message request queue of the virtual disk at a first moment;
obtain a second value of the available space at a second moment after the first moment; and
determine whether the virtual machine is currently in the internal abnormal state or the normal operating state based on whether the first value is same as the second value.

16. The electronic device according to claim 9, wherein the processor is further configured to execute the program to:
obtain a virtual device list in a virtual machine emulator corresponding to the virtual machine, the virtual device list at least including the virtual network card or the virtual disk;
obtain a virtual memory address of the virtual network card or the virtual disk in the virtual device list;
perform reading at the virtual memory address to obtain the message queue of the virtual network card or the virtual disk.
